(19) United States
(12) Patent Application Publication
(10) Pub. No.: US 2025/0157717 A1
(43) Pub. Date: May 15, 2025

(54) Air Core Coil

(71) Applicant: YAMAHA CORPORATION, Hamamatsu-shi (JP)

(72) Inventors: Masao NORO, Hamamatsu-shi (JP); Tsukasa SUENAGA, Hamamatsu-shi (JP); Yoshiro MIYAKE, Hamamatsu-shi (JP)

(21) Appl. No.: 19/024,181

(22) Filed: Jan. 16, 2025

Related U.S. Application Data
(63) Continuation of application No. PCT/JP2023/025886, filed on Jul. 13, 2023.

(30) Foreign Application Priority Data
Aug. 22, 2022 (JP) 2022-131913

(51) Int. Cl. H01F 27/24; H01F 27/28

(52) U.S. Cl. CPC H01F 27/24; H01F 27/2823

(57) ABSTRACT

An air core coil includes an extended toroidal core and a conductive wire. The extended toroidal core is made of a nonmagnetic material or a weakly magnetic material. The conductive wire is wound around the extended toroidal core.

### CROSS-REFERENCE TO RELATED APPLICATIONS

The present application is a continuation application of International Application No. PCT/JP2023/025886, filed Jul. 13, 2023, which claims priority to Japanese Patent Application No. 2022-131913, filed Aug. 22, 2022. The contents of these applications are incorporated herein by reference in their entirety.

### BACKGROUND

The present disclosure relates to an air core coil.

Inductors, specifically coils, can be broadly classified into magnetic-core coils, which have magnetic cores, and air-core coils, which lack magnetic cores.

For the same inductance, the size of a magnetic-core coil is significantly smaller than the size of an air-core coil. However, magnetic-core coils are prone to flux saturation in the magnetic core, leading to a higher likelihood of distortion. In contrast, air-core coils exhibit low distortion because flux saturation does not occur.

A typical air-core coil has such a structure that a conductive wire is wound in a circular shape without a core or is wound around a core made of a weakly magnetic or non-magnetic material. Since air-core coils exhibit no or minimal distortion, air-core coils are frequently used in applications such as network circuits in high-end speakers. However, since air-core coils exhibit significant magnetic flux leakage, when a plurality of coils are used, it is necessary to space the coils or orient the coils differently in order to avoid interference.

A type of magnetic core coil, known as a toroidal coil, involves winding a conductive wire around a toroidal magnetic core. A toroidal coil confines magnetic flux within the toroidal core, reducing external leakage and enabling close placement of a plurality of coils. However, even in a toroidal coil, the magnetic flux concentrates in the magnetic toroidal core, leading to a tendency for saturation to occur.

In audio-class D power amplifiers, pulse-width modulation (PWM) signals are generated by modulating an input signal's pulse width. Switching signals produced through switching of high-side and low-side transistors in accordance with the PWM signals are filtered using a low-pass filter (LPF) (see, for example, JP2004-72276A). Specifically, in class D power amplifiers, harmonic components of the switching signal are attenuated by the low-pass filter, resulting in production of an audio signal.

In such class D power amplifiers, the inductor constituting the LPF is implemented using either a magnetic core coil or an air core coil. The LPF allows a relatively large current to flow. This may lead to magnetic flux saturation in the core of a magnetic core coil. To enhance the quality of audio signals, it is preferable to use an air-core coil, which is less prone to magnetic flux saturation, as the inductor constituting the LPF.

In contrast, to avoid a significant increase in the size of a class D amplifier compared with use of a magnetic core coil, it is necessary to minimize the size of the air-core coil constituting the LPF. Air-core coils have a disadvantage of being larger in size compared with magnetic core coils.

With the above and other circumstances into consideration, it is an object of the present disclosure to provide an air-core coil capable of achieving greater inductance while maintaining an equivalent size.

### SUMMARY

One aspect is an air core coil that includes an extended toroidal core and a conductive wire. The extended toroidal core is made of a nonmagnetic material or a weakly magnetic material. The conductive wire is wound around the extended toroidal core.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a schematic illustration of an air core coil according to an embodiment;

FIG. 2 is a plan view of a core of the air core coil according to the embodiment;

FIG. 3 is a cross-sectional view of the core of the air core coil according to the embodiment;

FIG. 4 is a plan view of a core of an air core coil according to a comparative example;

FIG. 5 is a cross-sectional view of the core of the air core coil according to the comparative example;

FIG. 6 is a table showing a comparison between the comparative example and the embodiment;

FIG. 7 is a graph showing magnetic flux density of the core in the comparative example and the embodiment; and

FIG. 8 is a plan view of a core of an air core coil according to the comparative example.

### DESCRIPTION OF THE EMBODIMENTS

The present specification is applicable to an air core coil.

An air core coil according to an embodiment will be described by referring to the accompanying drawings.

It is to be noted that in the drawings, the dimensions and scales of various parts are appropriately altered from actual measurements. The embodiments presented below serve as illustrative examples of the present disclosure and are not intended to limit the scope of the present disclosure.

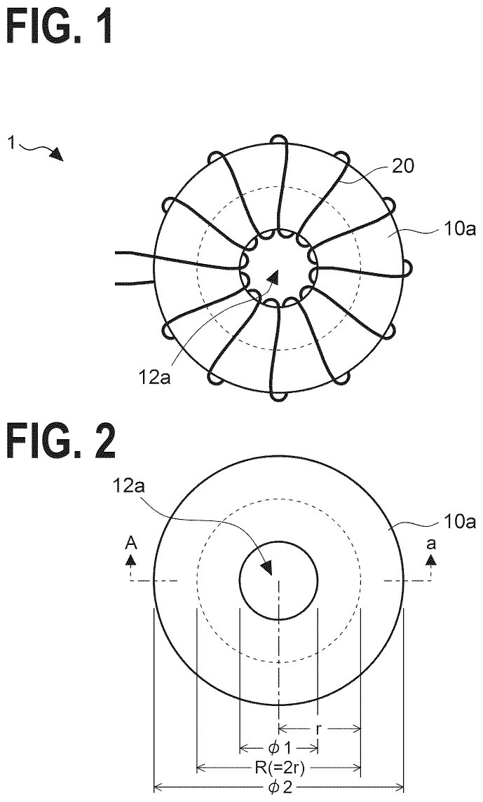

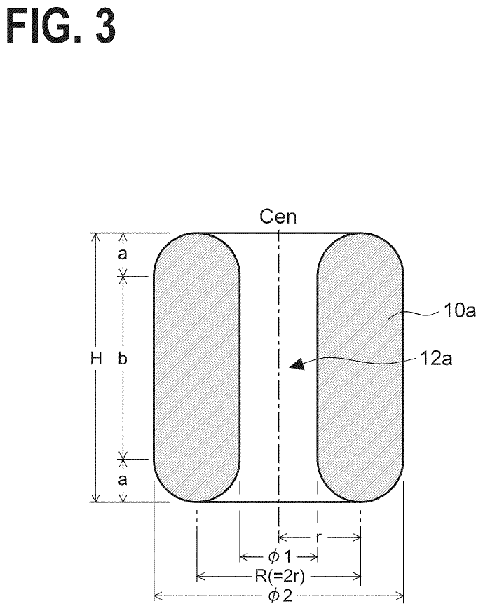

FIG. 1 is a plan view of a configuration of an air core coil 1 according to an embodiment. FIG. 2 is a plan view of a core 10a of the air core coil 1. FIG. 3 is a cross-sectional view of the core 10a illustrated in FIG. 2 cut along a plane indicated by line A-a.

In the air core coil 1, the core 10a is an extended toroidal core with an elongated-circle cross-sectional shape cut along the plane indicated by line A-a. The term “toroidal” refers to an axisymmetric shape formed by rotating a circular plate around a central axis Cen. The term “extended toroidal core” refers to a core with a shape formed by extending, in a direction along the central axis Cen, a toroid having a cross-section in the form of a circle with a radius of a. More specifically, the extended toroidal core has a shape obtained by dividing a toroid into upper and lower halves along a plane perpendicular to the central axis Cen and elongating the divided plane in the direction of the central axis Cen. In the core 10a, the extended circular cross-section has a shape illustrated in FIG. 3. Specifically, the shape is formed by connecting an upper semicircle with a radius of a, a rectangle measuring b in height and 2a in width, and a lower semicircle with a radius of a. It is to be noted that the cross-section of the toroidal shape before extension may be a square or a polygon.

It is also to be noted that a toroidal core with a circular cross-section is referred to as a “general toroidal core” in the following description to distinguish the general toroidal core from an extended toroidal core. It is also to be noted that shape of the extended toroidal core is specifically referred to as “extended annular body”. The term “annular body”, when used alone, refers to a shape without any specific limitation on the cross-sectional configuration.

The core 10a is formed, for example, by shaping a non-magnetic material into an extended annular body or by sintering non-magnetic powder into the shape of an extended annular body. As illustrated in FIG. 1, a conductive wire 20 is wound uniformly around an entire circumference of the core 10a. In magnetic core coils, even if the conductive wire is wound unevenly, magnetic flux is mostly confined within the magnetic core. In contrast, in air-core coils, magnetic flux leaks from areas with uneven winding of the conductive wire around the core. Therefore, in air-core coils, it is necessary to wind the conductive wire uniformly around the entire circumference of the core.

The number of turns of the conductive wire 20 is denoted as N. In FIG. 1, the number of turns N is 12; however, this is merely a practical arrangement for illustrative purposes and is not intended to limit the number of turns N to 12.

The radius of a magnetic path circle in the core 10a is designated as r. The magnetic path circle is a hypothetical circle formed by connecting the midpoint between the inner diameter, ø1, and the outer diameter, ø2, when viewed in plan view. This circle is represented by a dashed line in the figure. The circumference of the hypothetical circle is a mean magnetic path length/of the core 10a and is represented by as 2πr.

It is to be noted that the diameter of the magnetic path circle is denoted as R(=2r). It is also to be noted that the height of the core 10a is denoted as H. The height His defined as the sum of twice the radius a of the circular portions and the length b of the straight portion of the cross-sectional shape of the extended circle (2a+b).

In this embodiment, the height H and the diameter R of the magnetic path circle of the core 10a are in the following relationship.

H>R

The core 10a has a cross-sectional area SS, which corresponds to the area of the hatched extended circular region illustrated in FIG. 3 and is represented by πa²+ab.

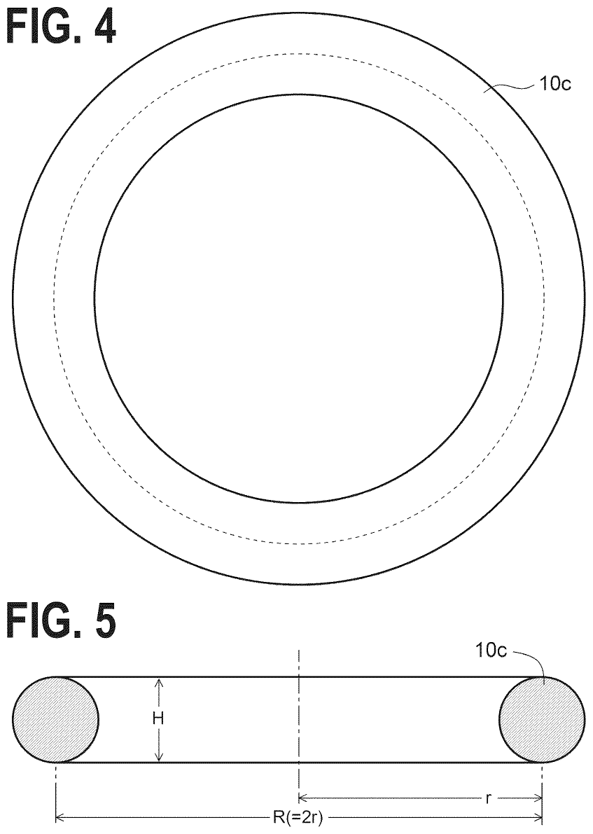

A comparative example will be described to explain advantages of the air core coil 1 according to the embodiment. FIG. 4 is according to a plan view of a core 10c of the air core coil of the comparative example. FIG. 5 is a cross-sectional view of the core 10c cut in the manner illustrated in FIG. 3. The core 10c according to the comparative example is an annular body, similarly to this embodiment. The core 10c, however, does not have an elongated-circle cross-sectional shape; instead, the core 10c has a cross-sectional shape, without a straight portion. That is, the core 10c is a general toroidal core.

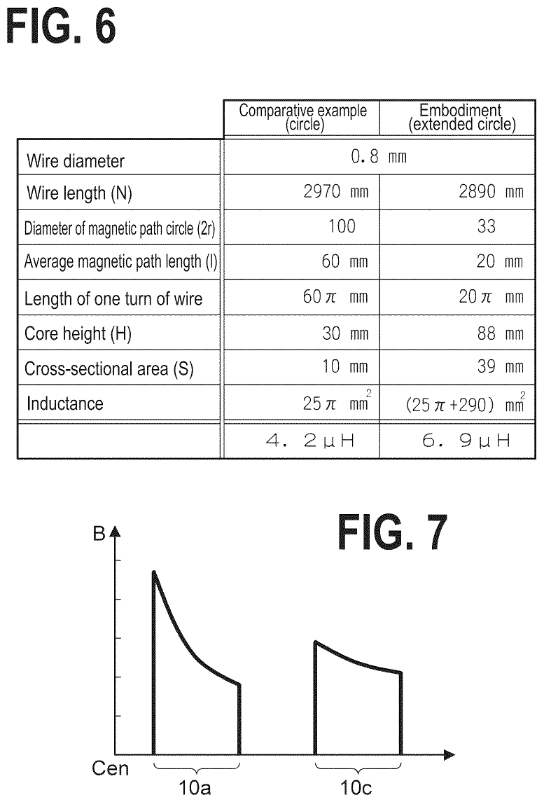

FIG. 6 is a table showing a comparison in dimensions, parameters, and other related factors between the comparative example and this embodiment. The following description is based on the assumption that the core 10a according to this embodiment has the dimensions (the diameter of the magnetic path circle and the height of the core) illustrated in FIG. 6 and that the conductive wire 20 has a wire diameter (diameter) of 0.8 mm and is wound by a number of turns N of 30. In this state, the conductive wire 20 wound around the core 10a has a wire length of 2890 mm. The magnetic path length of the core 10c according to the comparative example is designed such that the radius of the cross-sectional circle (half the height H) is the same as the radius a of the circle according to this embodiment, with the result that the wire length of the conductive wire 20 is approximately the same as the wire length of the conductive wire 20 according to this embodiment.

Self-inductance L [H] of a coil wound with a conductive wire around an annular core can be represented by the following equation.

$$L = {μ}_{0} {N}^{2} S / 2 π r \qquad ( 1 )$$

In the above equation, μ₀ is permeability of the core in a vacuum.

As evident from Equation (1), the self-inductance L of the coil is proportional to the square of the number of turns N, proportional to the cross-sectional area SS of the core, and inversely proportional to the average magnetic path length (L=2πr).

The self-inductance obtained by substituting the dimensions, parameters, and other related factors illustrated in FIG. 6 into Formula (1) is 4.2 μH for the comparative example and 6.9 μH for this embodiment. It is to be noted that Equation (1) is used to calculate the self-inductance L of a coil with the conductive wire wound around a general toroidal core and that applying this equation to an extended toroidal core, as in this embodiment, introduces inaccuracies. It is also to be noted that even with an actual general toroidal core, variations in magnetic flux density can occur between the inner and outer regions of the ring, making the self-inductance obtained from Equation (1) merely a reference value.

It is to be noted that as a result of electromagnetic field simulations performed by the inventor, the self-inductance in the comparative example was 4.4 μH whereas the self-inductance in this embodiment was 8.0 μH. Thus, this embodiment achieves significantly greater inductance compared with the comparative example. This point will be described below.

In this embodiment, the number of turns Nis approximately one-third of the number of turns N in the comparative example. As evident from Equation (1), Since the number of turns N influences the inductance calculation as a squared factor, examining the number of turns reveals that the inductance in the described embodiment is affected in a way that reduces the inductance to approximately one-ninth of the inductance in the comparative example.

However, the average magnetic path length l in this embodiment is one-third of the average magnetic path length l in the comparative example, and the cross-sectional area SS of the core in this embodiment is approximately 4.7 times the cross-sectional area SS in the comparative example.

For the average magnetic path length l, the inductance in this embodiment increases by 3 times compared with the comparative example. Regarding the cross-sectional area SS, the inductance in this embodiment increases by approximately 4.7 times compared with the comparative example.

In this embodiment, the cross-sectional shape of the core 10a is an extended circle. In this case, as compared with the comparative example, the reactance is more significantly influenced by the decrease in the average magnetic path length (l) and the increase in the cross-sectional area (S), rather by the decrease in the number of turns (N).

FIG. 7 is a graph showing magnetic flux density in the core 10a according to this embodiment and a core 10b in a comparative example with current flowing through the conductive wire 20 wound around each core. The graph shows results of electromagnetic field simulations. In the graph, the horizontal axis represents the radial distance from the central axis Cen of the core's ring, and the vertical axis indicates the strength of magnetic flux density B. In this embodiment, as compared with the comparative example, the magnetic flux density B exhibits a tendency to concentrate in the direction of the central axis Cen of the core 10a's ring.

As a result of the electromagnetic field simulations, in this embodiment, the magnetic flux density becomes higher on the inner side of the toroidal ring, causing the effective average magnetic path length to be shorter than the above-described 2πr. As a result, the inductance of the air-core coil according to this embodiment is 8.0 μH, which exceeds the 6.9 μH value calculated using Formula (1).

In this embodiment, the core is an annular body with a closed configuration, causing the magnetic flux to concentrate within the core. Therefore, the embodiment enables a reduction in magnetic flux leakage. Also in this embodiment, the air-core coil 1a includes the non-magnetic core 10a, and the conductive wire 20 is wound around the non-magnetic core 10a. As a result, the air-core coil 1a resists magnetic flux saturation. In this embodiment, the coil size can be reduced compared with the comparative example; in other words, this embodiment achieves a larger inductance with an air-core coil of equivalent size.

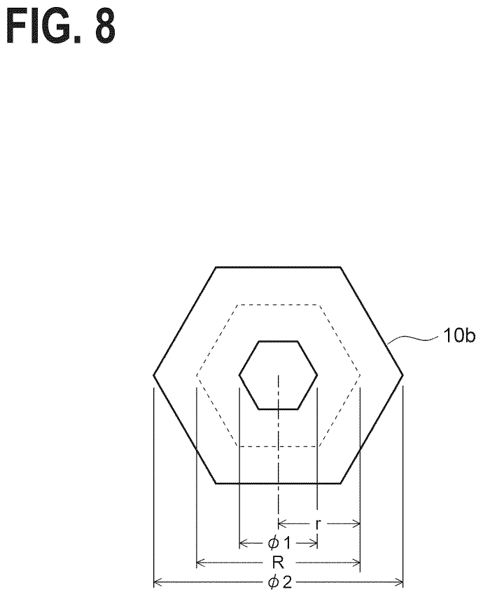

It is to be noted that while the core 10a according to this embodiment has a ring shape in plan view, this configuration is not intended in a limiting sense. FIG. 8 is a plan view of the core 10b according to the comparative example. As illustrated in FIG. 8, the core 10b may have a hexagonal cylindrical shape with an opening 12c extending along the central axis Cen. Generally, when a polygon with five or more sides is used, at least one angle becomes obtuse, reducing bending when the conductive wire 20 is wound and minimizing magnetic flux leakage. Thus, the core 10c can be described as having a polygonal shape with five or more sides and including the opening 12a.

In this embodiment, the core 10a is made of a nonmagnetic material; instead of a nonmagnetic material, a weakly magnetic material with low susceptibility to magnetic saturation may be used.

The air core coil 1 according to the embodiment may be used in applications such as speaker network circuits, in addition to serving as a low-pass filter (LPF) in a class D amplifier.

Preferred aspects of the present disclosure can be understood based on the foregoing description.

In a first aspect, the air core coil includes a toroidal core made of a nonmagnetic material or a weakly magnetic material and a conductive wire wound around the toroidal core. The toroidal core is an extended toroidal core. In the first aspect, a larger inductance is achieved with an air-core coil of equivalent size.

In a second aspect, which is a specific aspect of the first aspect, the extended toroidal core has a shape formed by extending an axially symmetric toroid in a direction of a central axis of symmetry of the toroid.

In a third aspect, which is a specific aspect of the first aspect, the extended toroidal core has a height greater than a diameter of the extended toroidal core. The second aspect reduces the coil size as compared with conventional air core coils. The phrase “reduces the coil size” is intended to mean achieving a smaller external volume for the same inductance.

In a fourth aspect, which is another specific aspect of the first aspect, the conductive wire is uniformly wound around an entire circumference of the extended toroidal core. In the third aspect, the conductive wire is uniformly wound around the entire circumference of the extended toroidal core. This configuration reduces magnetic flux leakage compared with configurations where the wire is not wound around the entire circumference of the core.

In a fifth aspect, which is another specific aspect of the first aspect, the extended toroidal core has a cylindrical shape and has an opening extending along a central axis of the extended toroidal core. In the fourth aspect, the extended toroidal core has a circular cylindrical shape. This configuration minimizes bending when the conductive wire is wound, reducing magnetic flux leakage.

In a sixth aspect, which is another specific aspect of the first aspect, the extended toroidal core has an opening extending along a central axis of the extended toroidal core, and has a polygonal cylindrical shape with five or more sides. In the fourth aspect, a polygonal shape with five or more sides can be regarded as equivalent to a cylindrical shape. When a polygon with five or more sides is used, at least one angle becomes obtuse, reducing bending when the conductive wire is wound and minimizing magnetic flux leakage.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. An air core coil comprising:
an extended toroidal core made of a nonmagnetic material or a weakly magnetic material; and
a conductive wire wound around the extended toroidal core.

2. The air core coil according to claim 1, wherein the extended toroidal core has a shape formed by extending an axially symmetric toroid in a direction of a central axis of symmetry of the toroid.

3. The air core coil according to claim 1, wherein the extended toroidal core has a height greater than a diameter of the extended toroidal core.

4. The air core coil according to claim 1, wherein the conductive wire is uniformly wound around an entire circumference of the extended toroidal core.

5. The air core coil according to claim 1, wherein the extended toroidal core has a cylindrical shape and has an opening extending along a central axis of the extended toroidal core.

6. The air core coil according to claim 1, wherein the extended toroidal core has an opening extending along a central axis of the extended toroidal core, and has a polygonal cylindrical shape with five or more sides.
